(19) United States
(12) Patent Application Publication
(10) Pub. No.: US 2026/0031405 A1
(43) Pub. Date: Jan. 29, 2026

(54) SECONDARY BATTERY

(71) Applicant: BYD Company Limited, Shenzhen (CN)

(72) Inventors: Xiaoqiang Yin, Shenzhen (CN); Ping Liu, Shenzhen (CN); Xiangyu Li, Shenzhen (CN); Tiancheng Sun, Shenzhen (CN); Shifa Liu, Shenzhen (CN)

(21) Appl. No.: 19/251,481

(22) Filed: Jun. 26, 2025

Related U.S. Application Data
(63) Continuation of application No. PCT/CN2023/120064, filed on Sep. 20, 2023.

(30) Foreign Application Priority Data
Dec. 30, 2022 (CN) 202223577445.5

(51) Int. Cl. H01M 10/0585; H01M 4/02; H01M 4/133; H01M 4/136; H01M 10/0525; H01M 10/054; H01M 50/119; H01M 50/124; H01M 50/426; H01M 50/434; H01M 50/446; H01M 50/46; H01M 50/491

(52) U.S. Cl. CPC H01M 10/0585; H01M 4/133; H01M 4/136; H01M 10/0525; H01M 10/054; H01M 50/119; H01M 50/1243; H01M 50/426; H01M 50/434; H01M 50/446; H01M 50/46; H01M 50/491; H01M 2004/021; H01M 2004/027; H01M 2004/028

(57) ABSTRACT

Secondary batteries are described, the batteries comprising a positive electrode layer, a negative electrode layer and an insulating layer. The insulating layer is located between the positive electrode layer and the negative electrode layer; the thickness of the positive electrode layer is about 10-200 mm; the thickness of the negative electrode layer is 5-150 mm; and the secondary battery meets the following condition: 20%≤a−(b/20)×5%≤35%; where the porosity of the insulating layer is a; and the thickness of the positive electrode layer is b mm. According to the secondary battery, the impedance of the secondary battery can be obviously reduced, and the capacity retention rate of the battery is increased in the long-term cycle process.

### CROSS-REFERENCE TO RELATED APPLICATIONS

The application claims priority to Chinese Patent Application filed with the China National Intellectual Property Administration on Dec. 30, 2022, with the application No. 202223577445.5 and the application title “A Secondary Battery”, the entire content of which is incorporated herein by reference.

### FIELD

The application relates to the field of battery technology, and in particular, to secondary batteries.

### BACKGROUND

Compared with the mainstream existing energy storage technology of pumped-storage hydroelectricity, the cost per unit of electricity of lithium-ion batteries is relatively high, which greatly restricts its further promotion. In the cost reduction of lithium-ion batteries, an important direction is to design thicker electrodes and batteries to reduce the use of unnecessary auxiliary materials, such as excessive foil, separator paper, housing, and electrolyte, in order to achieve the goal of reducing the cost of battery cells. This approach is also conducive to increasing the proportion of active materials in the battery, thereby improving the energy density.

In the design of thicker electrodes and batteries, the increase in electrode thickness can affect the diffusion efficiency of internal electrolyte ions between the positive and negative electrodes, increasing the diffusion resistance of the electrolyte ions. This, in turn, leads to an increase in the internal resistance of the battery, resulting in lower charging and discharging efficiency. How to reduce the resistance brought by the increased thickness of the electrode module to the internal lithium-ion conduction is crucial for achieving reasonable battery performance.

### SUMMARY

In response to the existing issue of high internal resistance in thick-electrode batteries, which affects charging and discharging efficiency, this application provides secondary battery designs.

A technical solution adopted by this application to solve the above-mentioned technical problem is as follows:

The application provides a secondary battery, including:
a positive electrode layer with a thickness ranging from about 10 to about 200 mm;
a negative electrode layer with a thickness ranging from about 5 to about 150 mm; and
an insulating layer located between the positive electrode layer and the negative electrode layer;
the secondary battery meets the following condition:
about 20%≤a−(b/20)×5%≤about 35%
wherein a is the porosity of the insulating layer; and
b is the thickness of the positive electrode layer in mm.

In some of the embodiments, the secondary battery meets the following condition:

$$25 \% ⩽ a - ( b / 20 ) \times 5 \% ⩽ 30 \% .$$

In some of the embodiments, the a is 20%-85%.

In some of the embodiments, the thickness ratio between the positive electrode layer and the negative electrode layer is (1˜2.5):1.

In some of the embodiments, the thickness of the insulating layer is 2-10 mm.

In some of the embodiments, the insulating layer is selected from an insulating filler layer, a porous membrane or a porous block.

In some of the embodiments, the insulating filler layer is selected from one of a Al₂O₃ powder layer, AlOOH powder layer, SiO₂ powder layer, PVDF powder layer or PTFE powder layer; and the porous membrane is selected from one of a PP membrane, PE membrane, PET membrane, PAN membrane or fiber glass membrane; and the porous block is selected from one of a porous PE block, porous PVDF block or porous PTFE block.

In some of the embodiments, the positive electrode layer includes a positive electrode material and a positive electrode current collector embedded in the positive electrode material, and the negative electrode layer includes a negative electrode material and a negative electrode current collector embedded in the negative electrode material.

In some of the embodiments, the positive electrode current collector and the negative electrode current collector each have a structure independently selected from a linear structure, a planar network structure or a three-dimensional network structure.

In some of the embodiments, the positive electrode layer, the negative electrode layer and the insulating layer are multi-layers, and where the multi-layers of the positive electrode layer, multi-layers of the insulation electrode layer and multi-layers of the negative electrode layer are arranged in a stacked configuration, and where the multi-layers of the electrode positive layer and multi-layers of the negative electrode layer are staggered arranged, with the insulating layer arranged between each adjacent positive electrode layer and negative electrode layer.

In some of the embodiments, the porosity of the positive electrode layer is 30%-80%, and the porosity of the negative electrode layer is 30%-80%.

In some of the embodiments, the porosity of the positive electrode layer gradually increases from the inner core to the outer surface of the positive electrode layer; and the porosity of the negative electrode layer gradually increases from the inner core to the outer surface of the negative electrode layer.

In some of the embodiments, the secondary battery further includes a housing in which the positive electrode layer, the negative electrode layer and the insulating layer are located.

In some of the embodiments, the housing is a metal housing and an insulating lining layer is arranged on the inner wall of the housing.

In some of the embodiments, the secondary battery further includes a positive electrode current collector terminal and a negative electrode current collector terminal, and the positive electrode current collector terminal is connected to the positive electrode current collector and leads to the outside of the housing, and the negative electrode current collector terminal is connected to the negative electrode current collector and leads to the outside of the housing.

In some of the embodiments, the secondary battery is a lithium-ion battery or a sodium-ion battery.

According to a secondary battery provided by this invention, an ultra-thick electrode battery is composed of a positive electrode layer with a thickness of about 10 to about 200 mm and a negative electrode layer with a thickness of about 5 to about 150 mm, in order to increase the energy density of the secondary battery and reduce the use of unnecessary auxiliary materials. Meanwhile, aiming to address the issue of increased internal resistance caused by thick electrodes, the inventors conducted experiments on the positive electrode layer and the insulating layer and found that the porosity a of the insulating layer and the thickness b of the positive electrode layer have an interactive effect on the diffusion of electrolyte ions. Specifically, when the porosity a of the insulating layer and the thickness b of the positive electrode layer meet the condition 20%≤a−(b/20)×5%≤35%, the impedance of the secondary battery can be significantly reduced, and the battery capacity retention rate can be improved during long-term cycling. It is speculated that under the above conditions, the porosity of the insulating layer is well-matched with the thickness of the positive electrode layer, which is conducive to improving the efficiency of electrolyte ion intercalation and deintercalation in the positive electrode layer, as well as the ion shuttling efficiency in the insulating layer. This, in turn, meets the electrolyte migration requirements for positive electrode layers of different thicknesses, thereby enhancing the rate performance and charging-discharging efficiency of the secondary battery.

### BRIEF DESCRIPTION OF THE DRAWINGS

FIG. 1 is a structural diagram of the secondary battery provided by this application.

The reference numerals in the drawings of the specification are as follows:
1. negative electrode layer; 2. insulating layer; 3. positive electrode layer; 4. negative electrode current collector terminal; 5. positive electrode current collector terminal.

### DETAILED DESCRIPTION

In order to make the technical problems, technical solutions, and beneficial effects addressed by this application clearer and more understandable, the following is a detailed description of this application in conjunction with the accompanying drawings and embodiments. It should be understood that the specific embodiments described here are merely for the purpose of explaining this application and are not intended to limit it.

In the description of this application, the term “thickness” refers to the distance between the two surfaces with the largest area of a layered structure. In this application, the positive electrode layer, the insulating layer, and the negative electrode layer are stacked along their thickness direction.

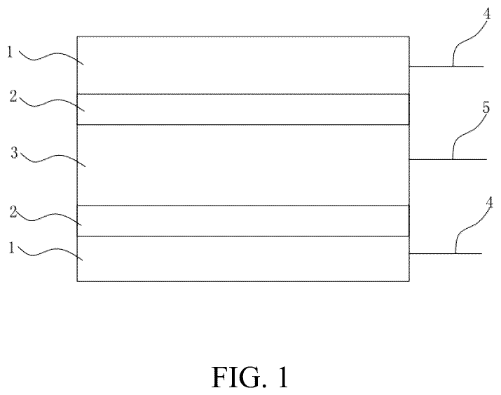

As shown in FIG. 1, an embodiment of this application provides a secondary battery, which includes a positive electrode layer 3, a negative electrode layer 1, and an insulating layer 2. The insulating layer 2 is located between the positive electrode layer 3 and the negative electrode layer 1. The thickness of the positive electrode layer 3 is about 10 to about 200 mm, and the thickness of the negative electrode layer 1 is about 5 to about 150 mm. The secondary battery meets the following conditions:

About 20%≤a−(b/20)×5%≤about 35%
wherein a is the porosity of the insulating layer; and
b is the thickness of the positive electrode layer in mm.

According to a secondary battery provided by this invention, a ultra-thick electrode battery is composed of a positive electrode layer 3 with a thickness of about 10 to about 200 mm and a negative electrode layer 1 with a thickness of about 5 to about 150 mm, in order to increase the energy density of the secondary battery and reduce the use of unnecessary auxiliary materials. Meanwhile, aiming to address the issue of increased internal resistance caused by thick electrodes, the inventors conducted experiments on the positive electrode layer 3 and the insulating layer 2 and found that the porosity a of the insulating layer 2 and the thickness b of the positive electrode layer 3 have an interactive effect on the diffusion of electrolyte ions. Specifically, when the porosity a of the insulating layer 2 and the thickness b of the positive electrode layer 3 meet the condition 20%≤a−(b/20)×5%≤35%, the impedance of the secondary battery can be significantly reduced, and the battery capacity retention rate can be improved during long-term cycling. It is speculated that under the above conditions, the porosity of the insulating layer 2 is well-matched with the thickness of the positive electrode layer 3, which is conducive to improving the efficiency of electrolyte ion intercalation and deintercalation in the positive electrode layer 3, as well as the ion shuttling efficiency in the insulating layer 2. This, in turn, meets the electrolyte migration requirements for positive electrode layers 3 of different thicknesses, thereby enhancing the rate performance and charging-discharging efficiency of the secondary battery.

In some of the embodiments, the secondary battery meets the following condition:

$$25 \% ⩽ a - ( b / 20 ) \times 5 \% ⩽ 30 \% .$$

By further restricting the range of the expressions as above, it is conducive to further alleviating the problem of increased electrolyte conduction impedance caused by electrode thickening, thereby achieving better capacity performance at low rates.

In some of the embodiments, the thickness of the positive electrode layers 3 can be about any of 10 mm, 20 mm, 30 mm, 40 mm, 50 mm, 60 mm, 70 mm, 80 mm, 90 mm, 100 mm, 110 mm, 120 mm, 130 mm, 140 mm, 150 mm, 170 mm, 190 mm, or 200 mm.

As the thickness of the positive electrode layer 3 increases, it is beneficial for improving the energy density of the battery. Meanwhile, the diffusion efficiency of electrolyte ions within the positive electrode layer 3 decreases. Therefore, it is necessary to adjust the porosity of the insulating layer 2 to comprehensively regulate the battery performance. Nevertheless, if the thickness of the positive electrode layer 3 is too large, it becomes difficult to reverse its impact on the increase in battery impedance through other factors. When the thickness of the positive electrode layer 3 is within the aforementioned range, on the one hand, it enhances the energy density of the secondary battery; on the other hand, it is also conducive to ensuring that the impedance of the secondary battery is within an appropriate range by coordinating with the porosity of the insulating layer 2.

When the thickness of the negative electrode layer 1 is within the aforementioned range, it is conducive to coordinating with the positive electrode layer 3 to regulate the ratio of the reversible capacity of the negative electrode and that of the positive electrode, enabling the secondary battery to have an appropriate NP ratio. This is beneficial for ensuring the energy density of the secondary battery while guaranteeing the uniform deposition of electrolyte ions inside the negative electrode layer 1, thereby enhancing the safety performance of the battery.

In some of the embodiments, the a is 25%-85%, that is, the porosity of the insulating layer 2 is 25%-85%.

Specifically, the porosity of the insulating layer 2 can be 25%, 35%, 45%, 55%, 65%, 75%, or 85%.

When the porosity of the insulating layer 2 is within the aforementioned range, it can suppress the occurrence of side reactions between the positive and negative electrodes. At the same time, it improves the shuttling efficiency of electrolyte ions within the insulating layer 2. This is conducive to reducing battery impedance while ensuring the cycling performance of the battery, and to enhancing the capacity retention rate of the battery.

In some of the embodiments, the thickness ratio of the positive electrode layer 3 to the negative electrode layer 1 is (1-2.5):1.

In some of the embodiments, the thickness ratio of the positive electrode layer 3 to the negative electrode layer 1 can be 1:1, 1.2:1, 1.5:1, 1.6:1, 1.7:1, 1.8:1, 1.9:1, 2.0:1, 2.1:1, 2.2:1, 2.3:1, 2.4:1 or 2.5:1.

By adjusting the thickness ratio of the positive electrode layer 3 to the negative electrode layer 1, the capacities of the positive electrode layer 3 and the negative electrode layer 1 can be regulated to be within an appropriate range. When the thickness ratio of the positive electrode layer 3 to the negative electrode layer 1 is within the aforementioned range, it is conducive to ensuring the full utilization of the capacities of both the positive electrode layer 3 and the negative electrode layer 1. At the same time, it helps to prevent the formation of metal dendrites.

In some of the embodiments, the thickness of the insulating layer 2 is 2-10 mm.

In some of the embodiments, the thickness of the insulating layer 2 can be 2 mm, 4 mm, 6 mm, 8 mm or 10 mm.

The thickness of the insulating layer 2 is related to the risk of short-circuiting in the battery and the shuttling efficiency of electrolyte ions. When the thickness of the insulating layer 2 is within the aforementioned range, it can effectively prevent the risk of contact between the positive electrode layer 3 and the negative electrode layer 1, and at the same time facilitate the shuttling of electrolyte ions.

In some of the embodiments, the insulating layer 2 is selected from an insulating filler layer, a porous membrane or a porous block.

The insulating filler layer is a layer of insulating powder accumulation. When the insulating layer 2 is selected from the insulating filler layer, it is only necessary to fill the insulating powder in the housing to obtain the insulating filler layer, which has the advantage of convenient operation.

When the insulating layer 2 is selected from the porous membrane, it has a relatively high ionic conductivity efficiency.

The porous block is an insulating block with a porous structure. When the insulating layer 2 is selected from the porous block, it has better structural strength, which is conducive to enhancing the puncture resistance of the insulating layer 2 and thereby improving the safety of the secondary battery.

In some of the embodiments, the insulating filler layer is selected from one of a Al₂O₃ powder layer, AlOOH powder layer, SiO₂ powder layer, PVDF powder layer or PTFE powder layer; and the porous membrane is selected from one of a PP membrane, PE membrane, PET membrane, PAN membrane or fiber glass membrane; and the porous block is selected from one of a porous PE block, porous PVDF block or porous PTFE block.

In some of the embodiments, the positive electrode layer 3 includes a positive electrode material and a positive electrode current collector embedded in the positive electrode material.

The positive electrode current collector is used for the collection and conduction of electrons from the positive electrode material. By embedding the positive electrode current collector into the positive electrode material, the contact area between the positive electrode material and the positive electrode current collector is increased, thereby reducing the electronic conduction impedance.

The positive electrode material includes a positive electrode active substance, a positive electrode binder, and a positive electrode conductive agent. The positive electrode active substance can be a lithium-ion battery positive electrode material or a sodium-ion battery positive electrode material. The lithium-ion battery positive electrode materials include one or more of the following: LiFePO₄, LiFeₓMn₁₋ₓPO₄(0≤x≤1), LiNiₓCo_{y}Mn_{1-x-y}O₂(0≤x≤1, 0≤y≤1), LiNiₓCo_{y}Al_{1-x-y}O₂(0≤x≤1, 0≤y≤1), LiNiₓCo_{y}Mn₂Al_{1-x-y-z}O₂(0≤x≤1, 0≤y≤1, 0≤z≤1), LiMn₂O₄, LiMnO₂, LiNiO₂, LiCoO₂, Li₂MnO₃, LiNi_{0.5}Mn_{1.5}O₂. The sodium-ion battery positive electrode materials include one or more of the following: Prussian white, NaNiₓFe_{y}Mn_{1-x-y}O₂(0≤x≤1, 0≤y≤1), Na₃V₂(PO₄)₃, Na₂FeP₂O₇, Na₂Fe₂(SO₄)₃. The positive electrode binders include one or more of the following: PVDF, PTFE, PEO. The positive electrode conductive agents include one or more of the following: graphite powder, carbon black, carbon nanotubes, graphene, polypyrrole, polyaniline, polythiophene.

In some of the embodiments, the negative electrode layer includes a negative electrode material and a negative electrode current collector embedded in the negative electrode material.

The negative electrode current collector is used for the collection and conduction of electrons from the negative electrode material. By embedding the negative electrode current collector into the negative electrode material, the contact area between the negative electrode material and the negative electrode current collector is increased, thereby reducing the electronic conduction impedance.

The negative electrode material includes a negative electrode active substance, a negative electrode binder, and a negative electrode conductive agent. The negative electrode active substances include one or more of the following: graphite, hard carbon, silicon, silicon monoxide, Li₄Ti₅O₁₂, TiO₂, Fe₂O₃, MoS₂. The negative electrode binders include one or more of the following: methylcellulose, styrene-butadiene rubber, polyacrylic acid, sodium alginate, polyimide, polyvinyl alcohol. The negative electrode conductive agents include one or more of the following: conductive graphite, Super P, carbon black, carbon nanotubes, graphene.

In some of the embodiments, the functional fillers can be optionally added to the positive electrode material and the negative electrode material. The functional fillers include conductive fillers and/or insulating fillers. The conductive fillers include one or more of the following: conductive carbon fibers, conductive carbon rods, and conductive carbon tubes. The insulating fillers include one or more of the following: fiber glass, Al₂O₃, and SiO₂.

In some of the embodiments, the positive electrode current collector and the negative electrode current collector are independently selected from a linear structure, a planar network structure or a three-dimensional network structure.

In some of the embodiments, the positive electrode current collector and the negative electrode current collector are independently selected from a planar network structure or a three-dimensional network structure.

Using planar network structures or three-dimensional network structures as the positive electrode current collector or the negative electrode current collector is beneficial for increasing the contact area between the positive electrode current collector and the positive electrode material, or between the negative electrode current collector and the negative electrode material, thereby reducing the interfacial electronic conduction impedance.

The positive electrode current collector and the negative electrode current collector are each independently selected from one or more of the following: Cu, Al, Ni, Fe, Mn, Ti, and conductive fibers.

In one embodiment, the positive electrode current collector is selected from Al, the negative electrode current collector is selected from Cu.

In some of the embodiments, the positive electrode layer 3, the negative electrode layer 1 and the insulating layer 2 are multi-layers, multi-layers of the positive electrode layer 3, multi-layers of the insulation electrode layer 2 and multi-layers of the negative electrode layer 1 are arranged in a stacked configuration, and multi-layers of the positive electrode layer 3 and multi-layers of the electrode negative layer 1 are staggered arranged, with the insulating layer 2 arranged between each adjacent positive electrode layer 3 and negative electrode layer 1.

Arranging the positive electrode layer 3, the negative electrode layer 1, and the insulating layer 2 into a multilayer structure is conducive to improving the spatial utilization rate of the secondary battery, enhancing the overall energy density, and further reducing the use of non-essential auxiliary materials.

In other embodiments, the positive electrode layer 3, the negative electrode layer 1 and the insulating layer 2 can also be a single layer.

In some of the embodiments, the porosity of the positive electrode layer 3 is 30%-80%, and the porosity of the negative electrode layer 1 is 30%-80%.

In some of the embodiments, the porosity of the positive electrode layer 3 is 30%-60%, and the porosity of the negative electrode layer 1 is 30%-60%.

When the porosity of the positive electrode layer 3 and the porosity of the negative electrode layer 1 are within the aforementioned range, on the one hand, it is conducive to improving the penetration efficiency of the electrolyte into the positive electrode layer 3 and the negative electrode layer 1, thereby enhancing the ionic conductivity. On the other hand, it ensures that the positive electrode layer 3 and the negative electrode layer 1 have a certain degree of structural strength, maintaining the structural stability of the positive electrode layer 3 and the negative electrode layer 1 during charge-discharge cycling.

In some of the embodiments, the porosity of the positive electrode layer 3 gradually increases from the inner core to the outer surface of the positive electrode layer 3; and the porosity of the negative electrode layer 1 gradually increases from the inner core to the outer surface of the negative electrode layer 1.

Setting the porosity of the positive electrode layer 3 and the negative electrode layer 1 to gradually increase from the inside to the outside is conducive to enhancing the infiltration effect of the electrolyte on the positive electrode layer 3 and the negative electrode layer 1, thereby improving the ionic conductivity.

In some of the embodiments, the secondary battery further includes a housing in which the positive electrode layer 3, the negative electrode layer 1 and the insulating layer 2 are located.

In some of the embodiments, the housing can be a metallic housing or an insulating housing. The metallic housing includes Fe, Al, and their alloy components, as well as plated or composite parts. The insulating housing includes one or more of the following: PE, PP, PTFE, PET, and PAN.

In some of the embodiments, the housing is a metal housing and an insulating lining layer is arranged on the inner wall of the housing.

The thickness of the housing is 5 mm to 100 mm, and the thickness of the insulating lining layer is 1 mm to 10 mm.

The insulating lining layer is used to prevent direct contact between the housing and the negative electrode layer 1 or the positive electrode layer 3, thereby avoiding the issue of housing short circuit.

The housing includes a cover plate and a shell with an opening, where the cover plate is used to seal the opening of the shell.

In some of the embodiments, the secondary battery further comprises a positive electrode current collector terminal 5 and a negative electrode current collector terminal 4, and the positive electrode current collector terminal 5 is connected to the positive electrode current collector and leads to the outside of the housing, and the negative electrode current collector terminal 4 is connected to the negative electrode current collector and leads to the outside of the housing.

By directly leading out the positive electrode current collector terminal 5 and the negative electrode current collector terminal 4 from the housing, the arrangement of a current collection structure in the housing can be avoided, thereby enhancing the energy density of the secondary battery.

In one embodiment, the positive electrode current collector terminal 5 is an aluminum rod with a diameter of 5 to 100 mm. When there is a plurality of the positive electrode layers 3, the plurality of positive electrode layers 3 lead out a plurality of positive electrode current collector terminals 5, and the plurality of positive electrode current collector terminals 5 form an aluminum rod array. The negative electrode current collector terminal 4 is a copper rod with a diameter of 5 to 50 mm. When there is a plurality of negative electrode layers 1, the plurality of negative electrode layers 1 lead out a plurality of negative electrode current collector terminals 4, and the plurality of negative electrode current collector terminals 4 form a copper rod array. The positive electrode current collector terminals 5 and the negative electrode current collector terminals 4 are led out from opposite sides of the housing.

In some of the embodiments, the secondary battery is a lithium-ion battery or a sodium-ion battery.

The following further illustrates the present application through embodiments.

TABLE 1

| | | | | Thickness | |
|---|---|---|---|---|---|
| | Thickness | | | Ratio of | |
| | of Single- | | Thickness | Positive | |
| | Layer | Porosity | of Single- | Electrode | |
| | Positive | of | Layer | Layer to | |
| | Electrode | Insulating | Negative | Negative | a − |
| | Layer | Layer | Electrode | Electrode | (b/20) × |
| Number | b/mm | a | Layer/mm | Layer | 5% |
| Embodiment 1 | 36.4 | 39.1% | 28.6 | 1.27 | 30.0% |
| Embodiment 2 | 65.1 | 45.2% | 51.2 | 1.27 | 28.9% |
| Embodiment 3 | 98.5 | 53.3% | 77.5 | 1.27 | 28.7% |
| Embodiment 4 | 142.2 | 64.8% | 112.1 | 1.27 | 29.3% |
| Embodiment 5 | 188.7 | 75.0% | 147.9 | 1.28 | 27.8% |
| Embodiment 6 | 200 | 70.0% | 155 | 1.29 | 20.0% |
| Embodiment 7 | 200 | 85.0% | 155 | 1.29 | 35.0% |
| Comparison | 36.4 | 25.1% | 28.6 | 1.27 | 16.0% |
| Example 1 | | | | | |
| Comparison | 65.1 | 33.5% | 51.2 | 1.27 | 17.2% |
| Example 2 | | | | | |
| Comparison | 98.5 | 41.2% | 77.5 | 1.27 | 16.6% |
| Example 3 | | | | | |
| Comparison | 142.2 | 50.8% | 112.1 | 1.27 | 15.3% |
| Example 4 | | | | | |
| Comparison | 188.7 | 61.2% | 147.9 | 1.28 | 14.0% |
| Example 5 | | | | | |
| Comparison | 36.4 | 47.0% | 28.6 | 1.27 | 37.9% |
| Example 6 | | | | | |
| Comparison | 35 | 45.2% | 27 | 1.30 | 36.5% |
| Example 7 | | | | | |

### Example Embodiment 1

The embodiment is used to illustrate the secondary battery and its preparation method disclosed in the present invention, which includes the following steps:

\textcircled{1}Lithium iron phosphate powder is mixed with conductive agent Super P and binder PVDF at a mass ratio of 90%:5%:5% using low-speed ball milling at a rotational speed of 50-100 rpm to obtain positive electrode active powder. Artificial graphite powder is mixed with conductive agent carbon black and binder PVDF at a mass ratio of 95%:2%:3% using low-speed ball milling at a rotational speed of 50-100 rpm to obtain negative electrode active powder. Al₂O₃ powder is mixed with the binder PVDF at a mass ratio of 95%:5% using low-speed ball milling at a rotational speed of 50-100 rpm to obtain insulating layer powder. \textcircled{2} The positive and negative electrode active powders and the insulating powder are layered and filled into an iron housing with dimensions of 0.5 m×0.5 m×0.5 m, which has been internally insulated, in the sequence of copper current collector mesh-negative electrode active powder-insulating powder-aluminum current collector mesh-positive electrode active powder. Negative electrode current collector is made of a three-dimensional copper mesh with a 1 cm×1 cm×1 cm aperture size, woven from copper wires with a diameter of 0.5 mm. Positive electrode current collector is made of a three-dimensional four-layer aluminum mesh with a 1 cm×1 cm×1 cm aperture size, woven from aluminum wires with a diameter of 1 mm. For each layer of negative electrode layer, 10 kg of material is added, and after leveling, it is hot-pressed to a layer thickness of 28.6 mm. For each layer of positive electrode layer, 20 kg of material is added, and after leveling, it is hot-pressed to a layer thickness of 36.4 mm. For each layer of insulating layer, 6.09 kg of material is added, and after leveling, it is hot-pressed to a layer thickness of 10 mm, with a porosity of 39.1%. The entire cell is consisted of 6 layers of negative electrodes, 5 layers of positive electrodes, and 10 layers of insulating layers. \textcircled{3} After the cell is formed, a cover plate is welded on, and then it is transferred to a vacuum oven at 105° C. for baking for 5 days. \textcircled{4} After baking, the cell is filled with electrolyte. The electrolyte used is a conventional lithium iron phosphate electrolyte, with a filling volume of 63 kg. \textcircled{5} The cell is subjected to normal formation and capacity testing.

### Example Embodiments 2-7

Embodiments 2 to 7 are used to illustrate the secondary battery and its preparation method disclosed in the present invention, which include most of the operational steps in Embodiment 1, with the differences being:

The thickness of the positive electrode layer, the thickness of the negative electrode layer, and the porosity of the insulating layer are adopted as shown in Table 1, and the overall thickness of the cell is controlled to be the same as in Embodiment 1.

### Comparison Examples 1-7

Comparison Example 1 to 7 are used to illustrate the secondary battery and its preparation method disclosed in the present invention, which include most of the operational steps in Embodiment 1, with the differences being:

The thickness of the positive electrode layer, the thickness of the negative electrode layer, and the porosity of the insulating layer are adopted as shown in Table 1, and the overall thickness of the cell is controlled to be the same as in Embodiment 1.

### Performance Testing:

The following performance tests are conducted on the positive electrode plates prepared as described above:

An electrochemical charge-discharge testing cabinet is used to conduct simulated charge-discharge tests on the individual cells prepared as described above. Specifically, under ambient temperature conditions (25±3° C.), a test current of 1000 A is applied, and simulated constant-current charge-discharge tests are performed within a voltage range of 2.0-3.65V to obtain the electrical performance data of the single cell.

The test results obtained are filled into Table 2.

TABLE 2

| | Average Discharge | |
|---|---|---|
| | Voltage | Discharge Capacity |
| Number | (V) | (Ah) |
| Embodiment 1 | 3.130 | 11920 |
| Embodiment 2 | 3.128 | 12038 |
| Embodiment 3 | 3.127 | 12099 |
| Embodiment 4 | 3.125 | 12154 |
| Embodiment 5 | 3.123 | 12187 |
| Embodiment 6 | 3.121 | 12202 |
| Embodiment 7 | 3.125 | 12237 |
| Comparison Example 1 | 3.003 | 10927 |
| Comparison Example 2 | 3.001 | 11138 |
| Comparison Example 3 | 2.995 | 11212 |
| Comparison Example 4 | 2.992 | 11334 |
| Comparison Example 5 | 2.985 | 11501 |
| Comparison Example 6 | 3.122 | 10305 |
| Comparison Example 7 | 3.121 | 10298 |

As can be seen from the test results in Table 2, compared with secondary batteries outside the scope of the limitations of the present application, secondary batteries under the conditions provided by the present invention have higher discharge voltage and discharge capacity. This indicates that by appropriately adjusting the thickness of the positive electrode layer and the porosity of the insulating layer, it is possible to mitigate the increased mass transfer impedance caused by the thickening of the electrodes, thereby achieving comparable capacity performance at low rates.

The above description is merely an exemplary embodiment of the present application and is not intended to limit the present application. Any modifications, equivalent substitutions, and improvements made within the spirit and principles of the present application should all be included within the scope of protection of the present application.

1. A secondary battery, comprising:
a positive electrode layer with a thickness ranging from 10 to 200 mm;
a negative electrode layer with a thickness ranging from 5 to 150 mm; and
an insulating layer located between the positive electrode layer and the negative electrode layer;
wherein the secondary battery meets a condition:
$$20 \% ⩽ a - ( b / 20 ) \times 5 \% ⩽ 35 \%$$
wherein a is a porosity of the insulating layer; and
b is the thickness of the positive electrode layer mm.

2. The secondary battery according to claim 1, wherein the secondary battery meets the following condition:
$$25 \% ⩽ a - ( b / 20 ) \times 5 \% ⩽ 30 \% .$$

3. The secondary battery according to claim 1, wherein a is 20%˜85%.

4. The secondary battery according to claim 1, wherein the thickness ratio between the positive electrode layer and the negative electrode layer is (1˜2.5):1.

5. The secondary battery according to claim 1, wherein the thickness of the insulating layer is 2˜10 mm.

6. The secondary battery according to claim 1, wherein the insulating layer is selected from an insulating filler layer, a porous membrane or a porous block.

7. The secondary battery according to claim 6, wherein the insulating filler layer is selected from an Al₂O₃ powder layer, an AlOOH powder layer, a SiO₂ powder layer, a PVDF powder layer or a PTFE powder layer; and wherein the porous membrane is selected from a PP membrane, a PE membrane, a PET membrane, a PAN membrane or a fiber glass membrane; and the porous block is selected from a porous PE block, a porous PVDF block or a porous PTFE block.

8. The secondary battery according to claim 1, wherein the positive electrode layer comprises a positive electrode material and a positive electrode current collector embedded in the positive electrode material, and the negative electrode layer comprises a negative electrode material and a negative electrode current collector embedded in the negative electrode material.

9. The secondary battery according to claim 8, wherein the positive electrode current collector and the negative electrode current collector each have a structure that is independently selected from a linear structure, a planar network structure or a three-dimensional network structure.

10. The secondary battery according to claim 1, wherein the positive electrode layer, the negative electrode layer and the insulating layer are multi-layers, wherein the multi-layers of the positive electrode layer, multi-layers of the insulation layer and multi-layers of negative electrode layer are arranged in a stacked configuration, and wherein the multi-layers of positive electrode layer and the multi-layer negative electrode layer are staggered arranged, with the insulating layer arranged between each adjacent positive electrode layer and negative electrode layer.

11. The secondary battery according to claim 1, wherein the porosity of the positive electrode layer is 30%-80%, and the porosity of the negative electrode layer is 30%-80%.

12. The secondary battery according to claim 1, wherein the porosity of the positive electrode layer gradually increases from an inner core to an outer surface of the positive electrode layer; and the porosity of the negative electrode layer gradually increases from an inner core to an outer surface of the negative electrode layer.

13. The secondary battery according to claim 8, further comprising a housing in which the positive electrode layer, the negative electrode layer and the insulating layer are located.

14. The secondary battery according to claim 13, wherein the housing is a metal housing and an insulating lining layer is arranged on and inner wall of the housing.

15. The secondary battery according to claim 13, wherein the secondary battery further comprises a positive electrode current collector terminal and a negative electrode current collector terminal, and the positive electrode current collector terminal is connected to the positive electrode current collector and leads to the outside of the housing, and the negative electrode current collector terminal is connected to the negative electrode current collector and leads to the outside of the housing.

16. The secondary battery according to claim 1, wherein the secondary battery is a lithium-ion battery or a sodium-ion battery.
